(19) United States
(12) Patent Application Publication
(10) Pub. No.: US 2010/0011048 A1
(43) Pub. Date: Jan. 14, 2010

(54) Methods And Systems For Resolving A Geospatial Query Region To A Network Identifier

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/170,821

(22) Filed: Jul. 10, 2008

(51) Int. Cl. G06F 15/16; G06F 7/06; G06F 17/30

(52) U.S. Cl. 709/201; 707/4; 709/204; 707/E17.014

(57) ABSTRACT

A method for resolving a geospatial query region to a network identifier includes receiving a request identifying a geospatial query region. The method includes sending a first query message identifying the geospatial query region to a first network directory service representing a first domain space including a first domain having a domain region at least partially present in the geospatial query region. The first network directory service includes a domain association between a second domain and the domain region and indicates a node in the second domain has a node region at least partially present in the domain region. The method includes receiving a first response identifying the second domain. The method includes sending, to a second network directory service, a second query message based on the identified second domain. The method includes receiving a second response including a network identifier for a node.

### RELATED APPLICATIONS

This application is related to the following commonly owned U.S. patent applications, the entire disclosure of each being incorporated by reference herein:

Application No. ______ (Attorney Docket No 1523/US) filed on even date herewith, entitled “METHODS AND SYSTEMS FOR RESOLVING LOCATION INFORMATION TO A NETWORK IDENTIFIER”; and

Application No. ______ (Attorney Docket No 1524/US) filed on even date herewith, entitled “METHODS AND SYSTEMS FOR RESOLVING A QUERY REGION TO A NETWORK IDENTIFIER”.

### BACKGROUND

In the current domain name system (DNS), a query identifying a region for returning a network identifier of a node associated with the region is not supported. In the current system, performing such a query is impractical. Region information is associated with a node in DNS currently by a LOC record as defined in the Internet Engineering Task Force (IETF) Request for Comments (RFC) 1876. LOC records are managed by DNS servers responsible for a DNS naming domain, such as example.com. A LOC record allows an IP address to be resolved to a location/region. A DNS server responsible for a specified name domain can include LOC records from any number of regions. LOC records for any given specified region are distributed across the DNS, and thus may be located on any number of DNS servers. That is, there is no DNS server that is authoritative or responsible for a specified region.

Further, applications, such as browsers, often need to know more than a host network address. For example, a browser identifies a service accessed by a host network address via a Uniform Resource Locator (URL). The current DNS provides service records for locating services of various types in a given non-geospatial domain. A DNS naming domain can span more than one subnet and can span multiple, disjoint geospatial regions. There is no standard way of locating a service in a specified geospatial region.

Accordingly, there exists a need for methods, systems, and computer program products for resolving a geospatial query region to a network identifier.

### SUMMARY

Methods and systems are described for resolving a geospatial query region to a network identifier. In one embodiment, the method includes receiving a request identifying a geospatial query region. The method includes sending a first query message identifying the geospatial query region to a first network directory service. The first network directory service represents a first domain space including a first domain having a domain region at least partially present in the geospatial query region. The first network directory service includes a domain association between a second domain in a second domain space and the domain region identified by the first domain. The domain association indicates a node in the second domain has a node region at least partially present in the domain region. The method includes receiving, based on the domain association, a first response identifying the second domain. The method includes in response to receiving the first response, sending, to a second network directory service, a second query message based on the identified second domain. The method includes receiving a second response including a network identifier for a node having a node region at least partially present in the geospatial query region.

In another embodiment, a method includes receiving, by a first network directory service representing a first domain space including a first domain having a domain region, an update message identifying a second domain in a second domain space. The second domain includes a node having a node region at least partially present in the domain region. The method includes associating the second domain with the domain region. The method includes receiving a query message identifying a geospatial query region. The method includes determining that the geospatial query region is at least partially present in the domain region. The method includes sending, in response to determining that geospatial query region is at least partially present in the domain region, a response message identifying the second domain.

In another embodiment, a method for associating a geospatial region with a domain including a node associated with the geospatial region includes receiving, by a second network directory service representing a second domain space, a message identifying a node region of a node in a second domain of the second domain space. The method includes generating a message identifying an association for creation between the second domain and a domain region of a first domain in a first domain space. The domain region at least partially present in the node region. The method further includes sending the message to a first network directory service representing the first domain space for identifying the first domain based on the identified association and creating the association.

In another embodiment, a system for resolving a geospatial query region to a network identifier is disclosed. The system includes a resolution interface component configured to receive a request identifying a geospatial query region. The system includes a domain resolver component configured to send a first query message identifying the geospatial query region to a first network directory service representing a first domain space including a first domain having a domain region at least partially present in the geospatial query region, the first network directory service including a domain association between a second domain in a second domain space and the domain region identified by the first domain, the domain association indicating a node in the second domain has a node region at least partially present in the domain region. The domain resolver component is configured to receive, based on the domain association, a first response identifying the second domain. The domain resolver component is configured to in response to receiving the first response, send, to a second network directory service, a second query message based on the identified second domain. The domain resolver component is configured to receive a second response including a network identifier for a node having a node region at least partially present in the geospatial query region.

In another embodiment, a system for resolving a query region to a domain identifier is disclosed. The system includes a message in-router component configured to receive, by a first network directory service representing a first domain space including a first domain having a domain region, an update message identifying a second domain in a second domain space wherein the second domain includes a node having a node region at least partially present in the domain region. The system includes a domain manager component configured to associate the second domain with the domain region. The system includes a message in-router component configured to receive a query message identifying a geospatial query region. The system includes a query engine component configured to determine that the geospatial query region is at least partially present in the domain region. The system includes a message out-router component configured to send, in response to determining that geospatial query region is at least partially present in the domain region, a response message identifying the second domain.

In another embodiment, a system for associating a geospatial region with a domain including a node associated with the geospatial region is disclose. The system includes a message in-router component configured to receive, by a second network directory service representing a second domain space, a message identifying a node region of a node in a second domain of the second domain space. The system includes a domain manager component configured to generate a message identifying an association for creation between the second domain and a domain region, at least partially present in the node region, of a first domain in a first domain space. The system includes a message out-router component configured to send the message to a first network directory service representing the first domain space for identifying the first domain based on the identified association and creating the association

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for resolving a geospatial query region to a network identifier according to an embodiment of the subject matter described herein;

FIG. 2 is a block diagram illustrating a system for resolving a geospatial query region to a network identifier according to another embodiment of the subject matter described herein;

FIG. 3 is a block diagram illustrating a system for resolving a query region to a domain identifier according to another embodiment of the subject matter described herein;

FIG. 4 is a block diagram illustrating a system for resolving a query region to a domain identifier according to another embodiment of the subject matter described herein;

FIG. 5 is a flow diagram illustrating a method for resolving a query region to a domain identifier according to another embodiment of the subject matter described herein.

FIG. 6 is a block diagram illustrating a system for resolving a geospatial query region to a network identifier according to another embodiment of the subject matter described herein;

FIG. 7 is a block diagram illustrating a system for resolving a query region to a domain identifier according to another embodiment of the subject matter described herein;

FIG. 8 is a flow diagram illustrating a method for associating a geospatial region with a domain including a node associated with the geospatial region according to another embodiment of the subject matter described herein.

FIG. 9 is a block diagram illustrating a system for associating a geospatial region with a domain including a node associated with the geospatial region according to another embodiment of the subject matter described herein; and

FIG. 10 is a block diagram illustrating a system for associating a geospatial region with a domain including a node associated with the geospatial region according to another embodiment of the subject matter described herein.

### DETAILED DESCRIPTION

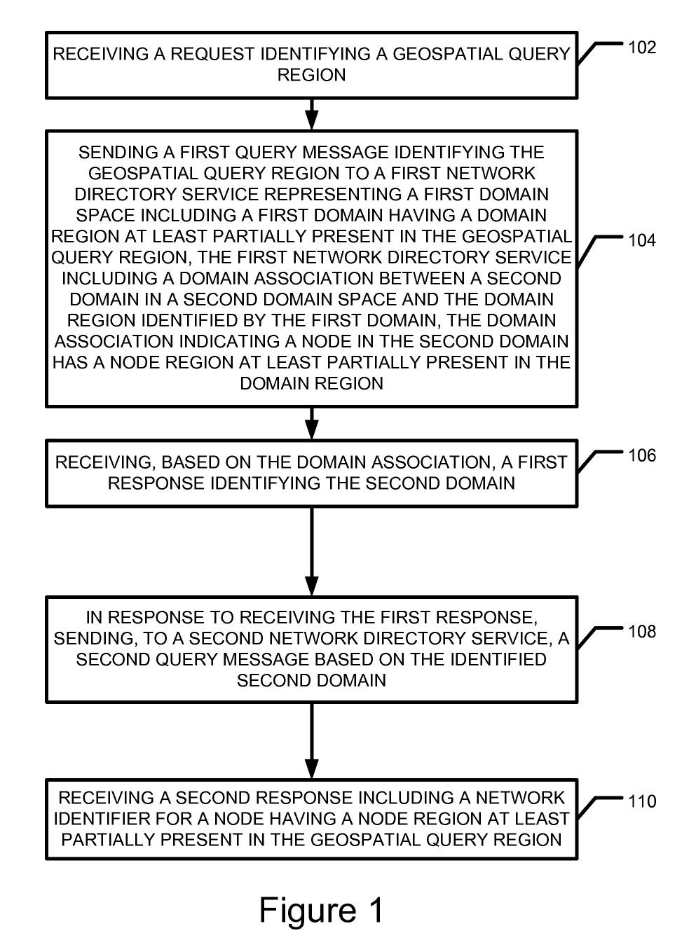

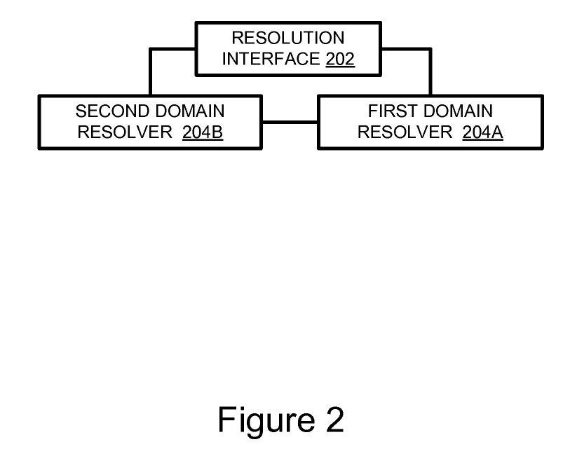

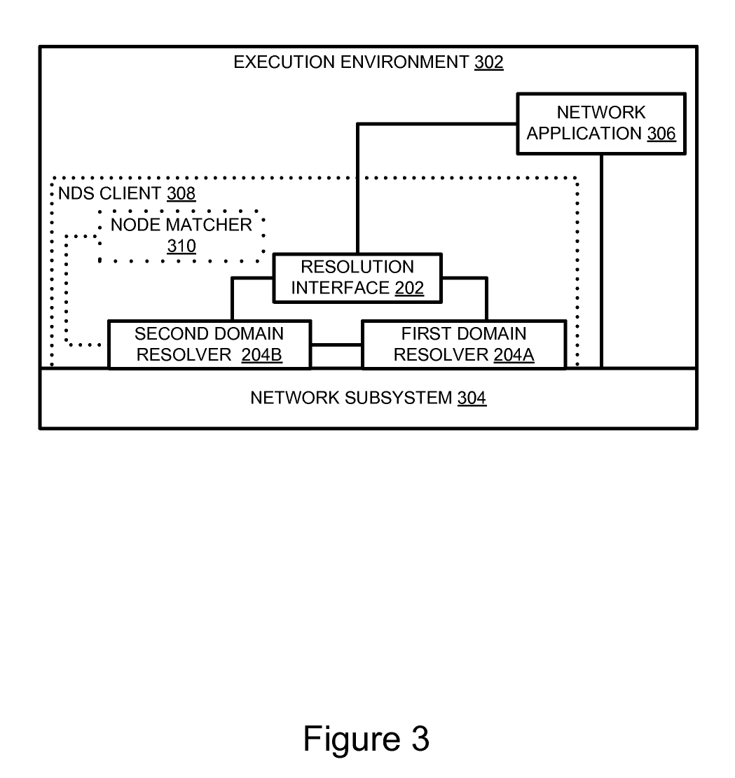

FIG. 1 is a flow diagram illustrating a method for resolving a geospatial identifier to a network identifier according to an exemplary embodiment of the subject matter described herein. FIG. 2 is a block diagram illustrating an arrangement of components for resolving a geospatial identifier to a network identifier according to an exemplary embodiment of the subject matter described herein. FIG. 3 is a block diagram illustrating an arrangement of components providing an execution environment configured to host the arrangement of components illustrated in FIG. 2. The method illustrated in FIG. 1 can be carried out by, for example, some or all of the components illustrated in the exemplary arrangement illustrated in FIG. 2 operating in a compatible execution environment, such as the execution environment illustrated in FIG. 3.

With reference to FIG. 1, in block 102 a request is received, the request identifying a geospatial query region. Accordingly, a system for resolving a geospatial query region to a network identifier includes means for receiving a request identifying a geospatial query region. For example, as illustrated in FIG. 2, a resolution interface component 202 is configured to receive a request identifying a geospatial query region.

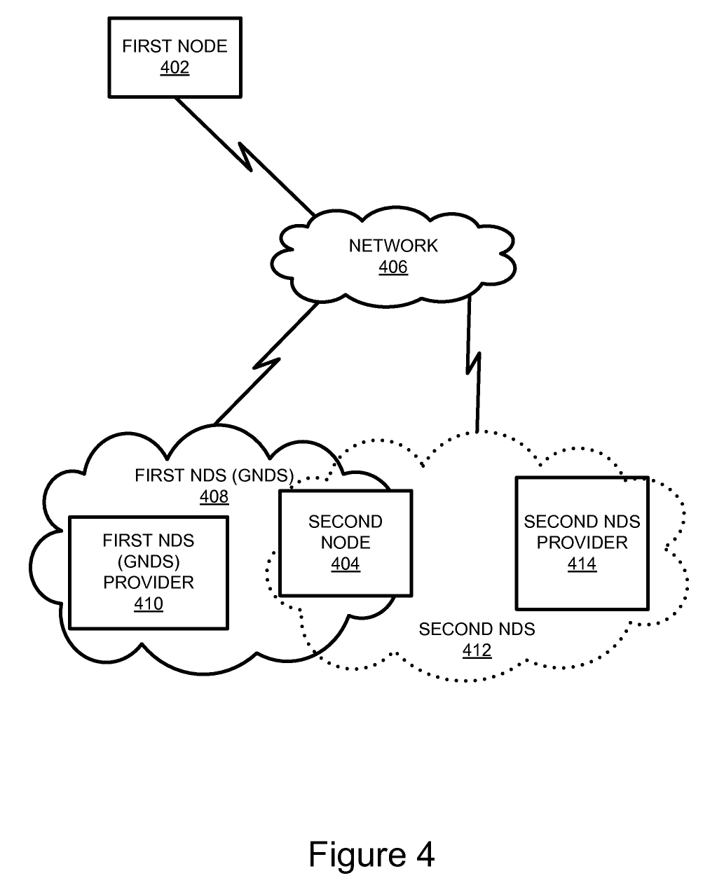

As discussed above, the components illustrated in FIG. 2 can be adapted for performing the method in a number of execution environments, such as the exemplary execution environment 302 illustrated in FIG. 3. An execution environment can be hosted by a node or can be hosted by multiple nodes as in a distributed execution environment. A node is any device operatively coupled to a network such as the Internet. In FIG. 4, a first node 402 can be configured to host the execution environment 302 adapted for supporting the operation of the arrangement of components illustrated in FIG. 2. A typical execution environment can include a memory for storing instructions and data, a processor for processing the instructions and data, a control program or operating system for managing the memory and processor making the instructions and data that is accessible to the processor. An operating system, persistent data storage subsystem, memory management subsystem, and a process scheduler are examples of components that can be required for various execution environments. The execution environment 302 can include other subsystems or components as required by the components illustrated in FIG. 2 for any particular configuration. For example, a network subsystem, such as the network subsystem 304 in FIG. 3, can be included in the execution environment 302 for communicating with a component in a remote device, such as a second node 404 over a network 406 as described below.

A network identifier is a logical identifier for a communication endpoint on a network. A network identifier includes at least one of a node portion identifying a node having a network interface in an identifiable portion of network and a domain portion identifying the identifiable portion of the network. Network identifiers are described in more detail below. A node can be any device having a network interface such as an Ethernet NIC and/or a wireless adapter.

According to an aspect, the request can identify a node portion of a network identifier identifying a node in a domain of the network. To identify the network interface of a node in another domain outside the domain of the node; the node portion can be combined with at least a portion of a domain portion identifying the domain of the node. The combined node portion and domain portion form a network identifier identifying the node outside the domain of the node. Example networks, each supporting a network identifier format(s), include IP networks, IPX networks, NetBIOS networks, ATM networks, among others. In another aspect, the node portion can be a valid node portion of both a geospatial identifier in a first domain space and an identifier in a second domain space.

As illustrated in FIG. 3 the resolution interface component 202 can be configured to receive the request from another component operating in the execution environment 302, such as a network application 306. The network application 306 can be configured to communicate via the network subsystem 304 with at least one network enabled application operating in at least one node. In order to communicate with a remote partner, the network application 306 can establish communication based on a network identifier, such as a network address or a network name for identifying the network address.

A network directory system (NDS) represents a domain space for network identifiers. An NDS can be configured to resolve a network identifier, such as a network name in a name domain space to a network address in an address domain space or vice versa in response to a request from the network application 306. An NDS includes one or more NDS servers operating in one or more execution environments provided by one or more nodes, referred to herein as NDS nodes. Each NDS server represents one or more domains each in the domain space represented by the NDS. For example, a DNS server can represent one or more domains in a naming domain space and/or an address domain space. The DNS is an NDS for resolving names from a name domain space to corresponding network addresses in an address domain space. The term NDS service, as used herein, can refer to at least one NDS server, at least one NDS node hosting the referred to NDS server(s), and a NDS including the referred to NDS server(s).

As described above, a network identifier is a logical identifier for a communication endpoint on a network. For example, an Internet Protocol (IP) address is a network identifier for communicating over an IP network such as the Internet. The DNS represents a name domain space that includes a set of names that are network identifiers. The DNS is configured to map a DNS name to a network address. A network identifier can be at least one of a network address and a symbolic identifier of a network address, such as a DNS name. A network address is a network layer address identifier for a network interface (e.g. unicast) or a set of interfaces (e.g. multicast or broadcast).

As described above, a network identifier can include a domain portion identifying a portion of a network and/or a node portion identifying a node having a network interface in the portion of the network identified by the domain portion. For example a network address, such as an Internet Protocol (IP) address, can include a domain portion referred to as a subnet ID. The partial IP address, 162.195.20, is an exemplary subnet ID that identifies a subnet. The nodes in the identified subnet can be identified outside the subnet by network addresses that include the IP address subnet identifier 162.195.20. To more precisely identify a subnet, an IP address or a portion of an IP address can be associated with a mask, such as 255.255.255.0. A mask identifies the subnet portion of an IP address via a logical “or” operation performed between each pair of bits identified by bit position in an IP address and the mask.

Analogously, a network name identifying a node, such as a DNS name, can include a domain portion identifying a naming domain of a network and optionally subdomains each identifying a portion of the network. For example, “nc.sceneralabs.com”, can identify a naming domain where a network interface of a node in the naming domain is associated with a name, such as, “placid”. The name “placid”, in the example, identifies the network interface of the node within the naming domain. The complete network name, “placid.nc.sceneralabs.com”, identifies the node when used outside the naming domain.

As discussed above, a network identifier can include a node portion that identifies a node having a network interface in a portion of the network identified by a domain portion of the network identifier. For example, in an IP address, a portion of the address is associated with a particular network interface in the identified subnet, thus identifying the network interface of the node. In the IP address 162.195.20.143 in the subnet 162.195.20.0/255.255.255.0, 143 is the node portion identifying a node having a network interface in the subnet. A subnet is a domain in the network address domain space. In a DNS name the first portion of the name identifies a node having a network interface in an identifiable domain in the DNS name domain space. As indicated, “placid” is the node portion identifying a network interface in the naming domain identified by “nc.sceneralabs.com”, and “placid.nc” is the node portion in a parent naming domain identified by the domain portion, “sceneralabs.com”.

There can be a one to one correspondence between a subnet in a network address domain and a domain in a naming domain, but a one to one correspondence is not required. For example, a domain in a naming domain space can be associated with one or more subnets or network portions. Further, a subnet can include network interfaces of nodes included in a single domain of a naming domain space or included in more than one naming domain in the domain space.

A domain space can include one or more nodes having network identifiers from the domain name space. A domain portion of a name from the domain name space, a portion of a network identified by the domain portion, a node portion of the name, and a node identified by the name can be said to be “in” and “included in” the domain space. Further, an identified portion of the network can be referred to as the domain. The node portion of the name, a network interface of the node identified by the node portion, and the node can be said to be “in” and “included in” the domain identified by the domain portion.

Analogously, a subnet portion of a network address from a domain address space, a portion of a network identified by the subnet portion, a node portion of the network address, and the node identified by the network address can be said to be “in” and “included in” the domain space. Further, an identified portion of the network can be referred to as the domain and/or subnet. The node portion of the network address, a network interface of the node identified by the node portion, and the node can be said to be “in” and “included in” the domain and/or subnet identified by the subnet portion

A geospatial domain space, for example, can include one or more regions where each region is associated with a domain in the geospatial domain space. For the purposes of this document, a region has a size that can be as large as the geospatial domain space in which it is included, or as small as can be identified. A location or region of a geospatial domain space can be associated with region information that uniquely identifies the region in the context of the geospatial domain space. Region information can include a geospatial identifier, which is discussed more fully below. The terms location and region are used interchangeably herein.

A domain in a domain space can have a geospatial region associated with the domain, referred to herein as a domain region. A domain region can be included in a real-world space or a geospatial virtual space. A region can be represented in a map and/or can be considered a region of a map. The association between a domain and a domain region can be based on a relationship between the domain region and the domain and/or a node having a network identifier in the domain. The relationship can be of any type, be unidirectional or bidirectional, and can have cardinality. For example, the relationship associating a domain with a domain region can be of a type based on at least one of an owner, a user, an administrator, a purchase of, a legal right associated with, an authentication service for, an authorization service for, a signer of a digital certificate for one or more of the domain, a node in the domain, and the domain region.

Returning to FIG. 3 and FIG. 4, when the network application 306, for example operating in the first node 402, has a first network identifier from a first domain space associated with the second node 404, but requires a network identifier of the second node 404 in a second domain space, the first identifier needs mapping or resolving to a second identifier included in a network address space for establishing communication based on the second identifier as a network address of the second node 404 and/or for some other purpose of the network application 306 such as presenting a network name of the second node 404 on a display.

According to an aspect, the request can include a geospatial identifier identifying the geospatial query region. For example, the geospatial query region can be represented as an identifier of a region in the first domain space. A geospatial identifier is any identifier that includes a portion that is usable for identifying a region/location of a geospatial domain space. Examples include:

postal://usa.nc.cary.corning-road:111.suite:220.placid

postal://placid.suite:220.corning_road:111.cary.nc.usa

postal://placid.suite:220:corning_road:111.27518.

Each of the above examples is from a geospatial domain space based the US Post Office postal address space.

The table below provides examples of three geospatial identifiers each from a different geospatial domain space specifying the same region, region A, on the Earth. The first geospatial identifier is from the World Geographic System (WGS) geospatial domain space. The second geospatial identifier is from the commonly known latitude/longitude geospatial domain space for addressing Earth regions. Each of the latitude and longitude coordinates can be expressed in degrees, minutes, and/or seconds. The third geospatial identifier is from the Global Positioning System (GPS) geospatial domain space.

| | WGS | | Deg/Min/Sec | | GPS | |
|---|---|---|---|---|---|---|
| Region | Latitude | Longitude | Latitude | Longitude | Latitude | Longitude |
| Region A | 30.29128 | −97.73858 | 30° 17′ 28″ | −97° 44′ 18″ | N30 17.477 | W97 44.315 |

Geospatial identifiers can be defined for specifying regions and locations having a variety of shapes such as a rectangle, circle, oval, or any shape including a closed region. A geospatial identifier can identify a region with disjoint sub-regions by including a geospatial attribute that identifies the sub-regions. For example, the identifier, “40+”, from an domain space including average annual rainfall totals over a specified period identifies a geospatial region including all sub-regions that have an average annual rainfall over 40 inches.

The query region identifier can be in a domain, such as a first domain and/or translatable to the first domain, in the first domain space when the region identified by the query region is at least partially present in a domain region of the first domain. The request is for mapping or resolving the geospatial query region to one or more domains in other domains spaces, such as the second domain in the second domain space as is described in detail below. The network application 306 can be configured to interoperate with a first NDS and a second NDS via an NDS client 308 illustrated in FIG. 3.

As illustrated in FIG. 3 and in FIG. 4, the arrangement of components can be configured to operate in the NDS client 308. The network application 306 can be configured to generate a request including an identifier of the geospatial query region for resolving the geospatial query region to a network identifier of a node in a second NDS 412 where the node has a node region that is at least partially present in the query region. The network address can be for establishing communication with the second node 404 as a communication partner. The request is received by the resolution interface component 202, as a function call for example. Other communication mechanisms can be used by the network application 306 and the resolution interface component 202. For example, the resolution interface component 202 can be configured to receive the request via a communication mechanism such as a pipe, a message queue, a shared data area and a semaphore, and/or a network depending on the capabilities of the execution environment 302 and the configuration of the resolution interface component 202.

A node can have a geospatial region associated with the node, referred to herein as a node region. The association between a node and a node region can be based on a relationship between the node region and the node. The relationship can be of any type, be unidirectional or bidirectional, and can have cardinality. For example, the relationship associating a node with a node region can be of a type based on at least one of an owner, a user, an administrator, a purchase of, a legal right associated with, an authentication service for, an authorization service for, a signer of a digital certificate for one or more of the node and the node region.

Returning to FIG. 1, in block 104 a first query message is sent, the first query message identifying the geospatial query region to a first network directory service. The first network directory service represents a first domain space including a first domain having a domain region at least partially present in the geospatial query region. The first network directory service includes a domain association between a second domain in a second domain space and the domain region identified by the first domain. The domain association indicates a node in the second domain has a node region at least partially present in the domain region. Accordingly, a system for resolving a geospatial query region to a network identifier includes means for sending a first query message identifying the geospatial query region to a first network directory service. The first network directory service represents a first domain space including a first domain having a domain region at least partially present in the geospatial query region. The first network directory service includes a domain association between a second domain in a second domain space and the domain region identified by the first domain. The domain association indicates a node in the second domain has a node region at least partially present in the domain region. For example, as illustrated in FIG. 2, a domain resolver component 204 is configured to send a first query message identifying the geospatial query region to a first network directory service. The first network directory service represents a first domain space including a first domain having a domain region at least partially present in the geospatial query region. The first network directory service includes a domain association between a second domain in a second domain space and the domain region identified by the first domain. The domain association indicates a node in the second domain has a node region at least partially present in the domain region.

The resolution interface component 202 can be configured to provide the identifier of the query region to the domain resolver component 204 for the first domain space, such as a first domain resolver component 204A. The geospatial region can be identified, for example, via any of a variety of geospatial identifiers provided in any suitable format as described above.

The first domain resolver component 204A can be configured to generate or provide for generating a message including a query referred to as a query message. The query identifies the geospatial query region, for example, by including a geospatial identifier in the query message. The query message can be sent by the first domain resolver component 204A via a network subsystem 304 for transmission from the first node 402 to a first network directory service illustrated as a first NDS 408 via the network 406. FIG. 4 indicates the first NDS 408 can be a geospatial network directory system (GNDS). A GNDS represents a domain space including geospatial network identifiers for identifying nodes in the domain space. According to an aspect, at least one of the first NDS and the second NDS can be a GNDS. According to an alternative aspect neither the first NDS nor the second NDS is a GNDS.

According to an aspect, a destination address for the first query message can be determined based on an identifier of a first network directory service accessible to a domain resolver component. For example, the domain resolver component 204 can be configured to determine a destination address for the first query message based on an identifier of the first network directory service. The identifier can include an identifier of the first NDS 408, an NDS node in the first NDS 408, and/or a NDS server representing a domain in the first domain space. In another aspect, a destination address for the first query message can be determined based on the geospatial query region. For example, the domain resolver component 204 can be configured to determining a destination address for the first query message based on the geospatial query region.

The first NDS 408 can include one or more NDS servers operating in one or more NDS nodes, such as a first NDS node 410. Each NDS node in the first NDS 408 provides an execution environment hosting an NDS server representing at least one domain in a first domain space represented by the first NDS 408. An NDS server and the NDS server's hosting NDS node can represent more than one domain in a domain space. A domain in a domain space can be represented by more than one NDS server by more than one NDS node

Each domain in the exemplary first domain space is associated with a geospatial region, which can be referred to as a domain region. The domain directly or indirectly identifies the associated domain region. The first NDS 408 maintains at least one association between a domain in another domain space where a node in the domain in the other domain space is associated with a node region that is at least partially present in a domain region identified by the domain represented by an NDS node in the first NDS 408, such as the first NDS node 410.

In FIG. 4, another NDS is illustrated as a second NDS 412 representing a second domain name space. The first domain name space and the second domain name space are illustrated as overlapping, thus indicating that a mapping exists between a first network identifier in the first domain space and a second network identifier in the second domain name space. As illustrated in FIG. 4, the second node 404 is associated with both the first network identifier and the second network identifier. The second node 404 is in a first domain including the first network identifier for the second node 404, and is also in a second domain including the second network identifier for the second node 404.

The first domain can be represented by the first NDS node 410 in the first NDS 408. The second domain can be represented by a second NDS node 414 in the second NDS 412. The second domain can include network identifiers in the form of network addresses from a network address domain space, such as IP addresses from the IP address space. Alternatively or additionally, the second domain can include network identifiers in the form of network names from a network name space, such as the node domain names from the domain name space associated with the Internet. A first NDS server and a second NDS server can operate in separate execution environments in separate NDS nodes or can operate in a shared execution environment in a shared NDS node(s).

According to an aspect, the second domain space is at least one of an Internet Protocol (IP) address domain space and a domain name system (DNS) name domain space. For example, the second domain space can be the current DNS name space or any network address space, such as the IP network address space of the Internet. The first NDS node 410 can be configured to maintain an association between the domain region of the first domain in the first NDS 408 and a domain in another domain space, such as the second NDS 412. The first NDS node 410 can include multiple associations. Each association identifies a domain in another domain space, the domain including a network interface of a node associated with a node region at least partially present in a domain region of the first domain. The first NDS node 410 can maintain domain identifiers from the second NDS 412 for each domain in the second NDS 412 that includes a node having a node region that is at least partially present in the domain region of the first domain which the first NDS node 410 represents.

The domain resolver component 204A can address the message to an NDS node in the first NDS 408 for delivery to the first NDS node 410 representing the first domain identifying a domain region at least partially including the query region. The address for sending the message can be provided, for example, via user configuration or provided by a service such as a Dynamic Host Configuration Protocol (DHCP) service provider as DNS service addresses are provided to nodes currently. Alternatively, a lookup service for mapping geospatial regions to addresses of NDS nodes can be included in the execution environment 302 or can be accessed remotely via a configured address stored in a memory included in the execution environment 302.

Returning to FIG. 1, in block 106 a first response identifying the second domain is received, based on the domain association. Accordingly, a system for resolving a geospatial query region to a network identifier includes means for receiving, based on the domain association, a first response identifying the second domain. For example, as illustrated in FIG. 2, the domain resolver component 204 is configured to receive, based on the domain association, a first response identifying the second domain.

For example, the domain resolver component 204A can be configured to receive a response from the first NDS 408. The response can be sent by the first NDS node 410 responsible for the first domain having the domain region that is at least partially present in the query region or can be sent from an NDS node that maintains a copy of at least portion of the associations maintained by the first NDS node 410. The response can be received via the network subsystem 304 as received from the network 406.

The received response can include a domain identifier for the second domain in the second NDS 412 that includes a node with a node region that is at least partially present in the query region. For example, FIG. 4 illustrates the second node 404 included in a second domain of the second NDS 412 represented by the second NDS node 414 and also included in the first domain of the first NDS 408 represented by the first NDS node 410. The first NDS node 410 can be configured to return all domain identifiers it maintains in associations with the domain region of the first domain. Alternatively, the first NDS node 410 can be configured to maintain node region information for at least one of the nodes with node regions that are at least partially present in the domain region of the first domain. The first NDS node 410 can be configured to identify domain identifiers with node regions that are at least partially present in the query region, thereby filtering the number of domain identifiers returned in the response. Regardless of the alternative, the first NDS node 410 generates a response including information identifying a domain in the second NDS 412 or other domain space supported. For example, a domain identifier of the second domain including the second node 404 in the second NDS 412 can be included in the response.

The domain resolver component 204A operating in the execution environment 302 hosted in the first node 402 can receive the response transmitted over the network 406 via the network subsystem 304. The response identifies the second domain in the second NDS 412 where the identified second domain includes the second node 404. The second node 404 is associated with a node region that is at least partially present in the domain region of the first domain represented by the first NDS node 410 for the first NDS 408. The first domain can be identified based on the domain region. The domain region can be identified based on the first domain.

According to an aspect, receiving the request includes receiving the request by a domain resolver component included in at least one of a client node, wherein the request is received from an application operating in the client node; a network directory service, wherein the request is received from a client node of the network directory service; and a proxy service for responding to the request by interoperating with at least one of a first network directory service and a second network directory service, wherein the request is received from a client node

Returning to FIG. 1, in block 108 a second query message is sent, in response to receiving the first response, to a second network directory service based on the identified second domain. Accordingly, a system for resolving a geospatial query region to a network identifier includes means for, in response to receiving the first response, sending to a second network directory service a second query message based on the identified second domain. For example, as illustrated in FIG. 2, the domain resolver component 204 is configured to, in response to receiving the first response, send to a second network directory service a second query message based on the identified second domain.

The domain resolver component 204A in FIG. 2 can be configured to identify the second domain identified in the received response to a second domain resolver component 204B. FIG. 2 illustrates a domain resolver component 204 for each of the two domains. Alternatively, a single domain resolver component can be configured to interoperate with multiple network directory services including the first NDS 408 and the second NDS 412. In receiving information identifying the second domain, such as the domain identifier, the second domain resolver component 204B can be configured to generate a second query message to be sent to an NDS node hosting a NDS server in the second NDS 412. Alternatively, the second query message can be generated by another component and provided to the second domain resolver component 204B for sending.

The second query message can identify the second domain in the second NDS 412, for example by including an identifier of the second domain in the second query message. According to an aspect, the second query message can include a matching criterion for determining a network identifier for the node having a node region at least partially present in the query region. For example, the domain resolver component 204 can be configured to include a matching criterion in the second query message. Matching criteria can include information identifying one or more of a geospatial query region, at least a node portion of a network identifier identifying a node in a particular domain, a service type, the first NDS 408 and any other available attribute that can be associated with a node as a matching criterion. The second NDS 412 can filter the content of a corresponding response to the second query message based on the matching criterion. A node portion of a network identifier can be identified in the request identifying the geospatial query region received by the resolution interface component 202 from the network application 306. When provided by the network application 306 the node portion and/or the geospatial query region can be provided to the second domain resolver component 204B through interoperation with the resolution interface component 202 as part of generating the second query message. Alternatively, the node portion and/or the geospatial query region can be provided to the second domain resolver component 204B from the resolution interface component 202 via the first domain resolver component 204A or another component.

As illustrated in FIG. 3 and FIG. 4, the second domain resolver component 204B operating in the execution environment 302 provided by the first node 402, sends the generated second query message via the network subsystem 304 over the network 406. The second query message can be addressed and/or routed by the second NDS 412 to a second NDS node 414. The recipient second NDS node 414 can be determined by the second NDS 412 based on an identifier of the second domain and routed to the second NDS node 414 responsible for the second domain. The second NDS node 414 can be authoritative for the second domain.

Alternatively, the second NDS node 414 can be a slave NDS server and/or maintain a cache including at least a portion of second domain data maintained by an NDS server that is authoritative for the second domain. At least one of the second NDS 412 and the first NDS 408 can be organized hierarchically, for example, as the DNS is. The routing of query messages including the second query message can be based on the hierarchical structure. Alternatively, at least one of the exemplary network directory services can support a peer-to-peer structure based on a peer-to-peer protocol for routing messages. Alternatively, at least one of the exemplary network directory services can support a centralized network architecture in at least a portion of either or both services where routing of messages is performed through a central node. Additionally or alternatively, each NDS server's address can be determined by a domain resolver component based on a domain identifier for addressing a message to a particular NDS server.

Returning to FIG. 1, in block 110 a second response is received. The second response includes a network identifier for a node having a node region at least partially present in the geospatial query region. Accordingly, a system for resolving a geospatial query region to a network identifier includes means for receiving a second response including a network identifier for a node having a node region at least partially present in the geospatial query region. For example, as illustrated in FIG. 2, the domain resolver component 204 is configured to receive a second response including a network identifier for a node having a node region at least partially present in the geospatial query region.

In FIG. 2, the second domain resolver component 204B can be configured to receive the second response, corresponding to the second query message via a network. The message can be sent from the second NDS 412, for example originating from the second NDS node 414. When the second query message identifying the second domain does not include a matching criterion, the second NDS node 414 can be configured to return a network identifier for each node in the identified domain in the second response. The second NDS node 414 can be configured determine a network identifier of a node in the identified domain to include in the response based on matching criteria including the geospatial query region, a node portion of a network identify identifying a node in a particular domain, a service type, the first NDS 408 and any other available attribute. When a node portion is included in the second query message, the second NDS node 414 can be configured to locate a network identifier of a node with a matching node portion. A network identifier with a matching node portion can be included in the second response.

According to an aspect, the response to the first query message can include more than one domain identifier in one or more domain spaces represented by one or more network directory services. As a result, one or more second query messages can be sent by one or more domain resolver components, such as the first domain resolver component 204A or the second domain resolver component 204B, of the one or more network directory services. Thus, one or more second responses corresponding to the one or more second query messages can be received by one or more domain resolver components 204. Including at least one of the geospatial query region, a node portion identifying a node in a particular domain, a service type, the first NDS 408 and any other available attribute of node allows NDS nodes receiving a second query message to filter network identifiers. A matching network identifier must have a corresponding node region that is at least partially present in the geospatial query region. Smaller geospatial query regions and smaller node regions can reduce returned network identifiers in the one or more second responses. According to an aspect, a second response can include one or more network identifiers from a second NDS node representing a second domain. The one or more network identifiers can be included in a second name space of the second domain and/or can be included in other name spaces of other domains in other domain spaces.

According to an aspect, the second response can include a plurality of network identifiers. The network identifier of the node can be determined from the plurality of network identifiers based on a matching criterion. For example, the domain resolver component 204 can be configured to determining the network identifier of the node from the plurality of network identifiers based on the matching criterion, as described above. Determining that a node has a corresponding node region that is at least partially present in query region can be performed by an NDS node processing the second query.

According to an aspect, this determination can be performed on the client by, for example, a node matcher 310 optionally provided. If, for example, a matching criteria is a node portion represented as a media access control (MAC) address, a single unique network identifier can be determined that has a node region that is at least partially present in the geospatial query region, since MAC addresses are globally unique. The matching of node portions can likewise be performed by an NDS server in processing a second query message and/or can be performed on the requesting client, such as the node 402. A node matcher 310 can be configured to match node portions of network identifiers returned in the one or more second responses. Analogously, the node matcher 310 can be configured to match a query region, a domain identifier, a service type, an identifier of the first NDS 408 optionally including an identifier of the domain associated with the first response message, and any other available attribute of node matching information.

A network identifier, such as a network identifier for the second node 404, received in a second response that has a corresponding node region at least partially present in the geospatial query region as describe above, can, in FIG. 3, be provided to the network application 306 by the resolution interface component 202 interoperating with the second domain resolver component 204B, and optionally the node matcher 310. The network application 306 can establish communication with a communication partner hosted by the second node 404 based on the network identifier. Further, according to an aspect, the second response can include an indicator identifying a level of trust of an association between the network identifier and the domain region. Levels of trust can, for example, be based on self reported region information by an unauthenticated node, an authenticated node, or an authenticated node verified by a trusted third party node. Further, the level of trust can be based on time and distance between a current location and a previous location.

According to an aspect, at least one of the first query message, the first response, the second query message, and the second response is formatted according to a domain name system (DNS) protocol. For example, the domain resolver component 204 can be configured to format at least one of the first query message and the second query message according to a domain name system (DNS) protocol. In another aspect, at least one of the first query message, the first response, the second query message, and the second response is formatted according to a publish-subscribe protocol. For example, the domain resolver component 204 can be configured to format at least one of the first query message and the second query message according to a publish-subscribe protocol, such as a presence protocol.

A presence protocol is a specialized publish-subscribe protocol including a status field. The architecture, models, and protocols associated with presence services in general are described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society. While the various presence aware IM applications described above may user proprietary architectures and protocols to implement their presence service components, each of the applications use presence architectures and protocols that are consistent with the presence model and protocols described in RFC 2778 and RFC 2779 in terms of features and function.

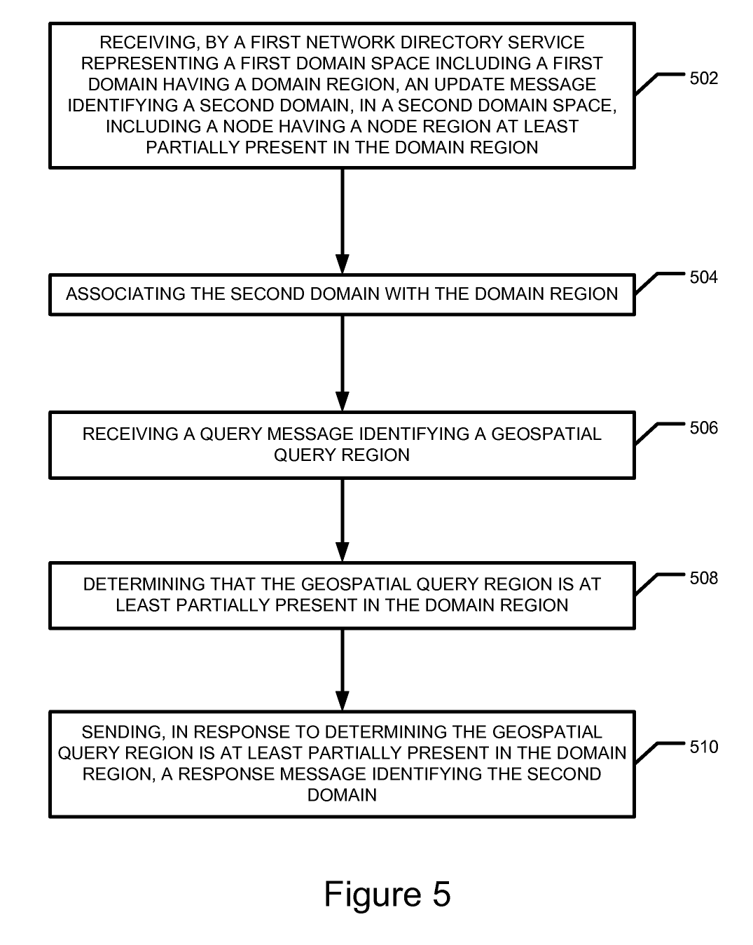

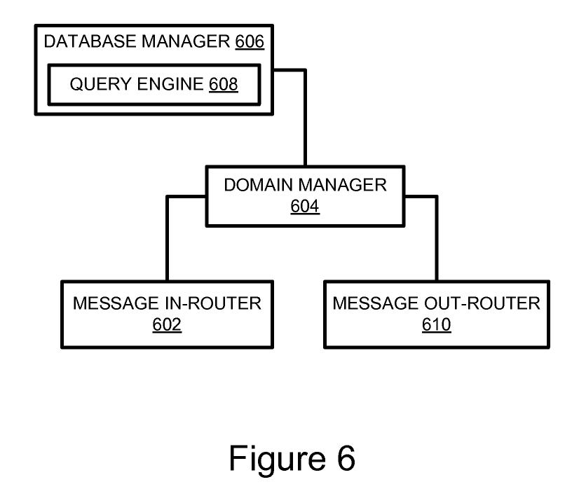

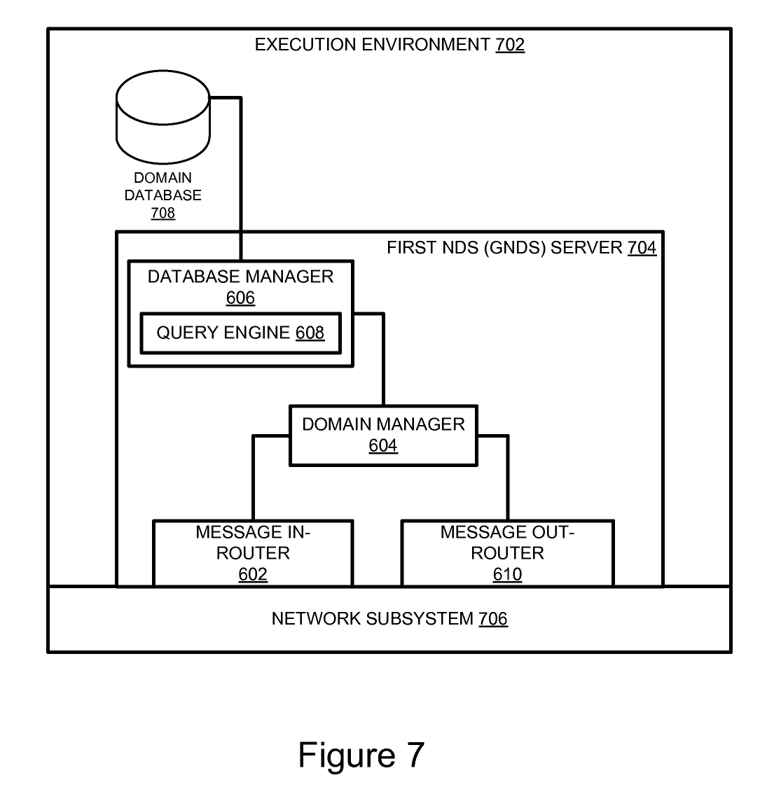

FIG. 5 is a flow diagram illustrating a method for resolving a query region to a domain identifier according to an exemplary embodiment of the subject matter described herein. FIG. 6 is a block diagram illustrating an arrangement of components for resolving a query region to a domain identifier according to another exemplary embodiment of the subject matter described herein. FIG. 7 is a block diagram illustrating an arrangement of components providing an execution environment configured to hosting the arrangement of components illustrated in FIG. 6. The method illustrated in FIG. 5 can be carried out by, for example, some or all of the components illustrated in the exemplary arrangement operating in a compatible execution environment, such as the environment illustrated in FIG. 7.

With reference to FIG. 5, in block 502 a first network directory service representing a first domain space including a first domain having a domain region receives an update message. The update message identifies a second domain in a second domain space. The second domain includes a node having a node region at least partially present in the domain region. Accordingly, a system for resolving a query region to a domain identifier includes means for receiving, by a first network directory service representing a first domain space including a first domain having a domain region, an update message identifying a second domain, in a second domain space, including a node having a node region at least partially present in the domain region. For example, as illustrated in FIG. 6, a message in-router component 602 is configured to receive, by a first network directory service representing a first domain space including a first domain having a domain region, an update message identifying a second domain, in a second domain space, including a node having a node region at least partially present in the domain region.

The second NDS 412 in FIG. 4 can maintain an association between a node and a corresponding node region. For example, a LOC record can map an IP address of a node to a node region. The mapping can indicate the node has a node region where the node is physically located in the node region, represents the node region, represents an entity in the node region, and/or is otherwise associated with the node region.

Further, an association between a node and a node region can change. For example, a server hosting a website for a company can be associated with a physical region of the company's home office as the server's node region. The server can be housed in a facility in a different region by a web site hosting service. The company can change hosting providers resulting in moving the server to yet another region that has no overlap with the two previously mentioned regions. The IP address of the web site can change requiring the new LOC record associating the new IP address with the new region and removal of the old LOC record. Alternatively, the company can move its office to a new region or associate the website with a region including another facility associated with the company. The IP address, in this case, is associated with the new region by updating the existing LOC record.

When an association between a network identifier and a node region is changed in the second NDS 412, a NDS node, such as the second NDS node 414, is configured to send an update message via the network 406 to the first NDS 408. An update message can be sent in response to a new association of a network identifier of a node in the second domain space with a node region, an update to an existing association, and/or a deletion of an existing association. The update message identifies the domain in the second domain space that includes the node identified by the network identifier in the updated association. For example, if an association between a network identifier associated with the second node 404 and a node region of the second node 404 is updated by, for example the second NDS node 414, the message received by the first NDS 408 identifies a domain in the second domain space, i.e. the second domain. The identified second domain is associated with the update. Additionally, the update message and/or another associated update message can identify a domain in a first domain space represented by the first NDS affected by the update. According to an aspect, the first domain space represented by the first NDS can be a geospatial domain space. In another aspect, at least one of the first domain space and the second domain space can be a geospatial domain space. A virtual geospatial domain space is a type of geospatial domain, and, thus can be represented by an NDS.

For example, when the update in the second NDS 412 results in no node in the second domain being associated with a node region that is at least partially present in the domain region identified by the first domain, the message can be received by the first NDS 408 for removing an existing association between the second domain and the domain region identified by the first domain represented by the first NDS node 410. Alternatively, the update message can identify the second domain and the first domain and indicate that the second domain includes a node, the second node 404, that is associated with a node region at least partially present in a domain region identified by a domain, the first domain, represented by the receiving first NDS 408.

The first domain can be identified by including an identifier of the affected node region. Alternatively, the second NDS node 414 can maintain a list of all domains in the first NDS 408 that include a node, also in the second domain, having a node region at least partially present in at least one of the domains in the first domain space represented by the first NDS 408. The list allows the second NDS node 414 to determine an identifier of a domain in the first NDS 408. The update message can be routed via the first NDS 408 or sent directly to the first NDS node 410 via any of the methods described above for routing query messages.

FIG. 6 illustrates the message in-router component 602 configured to receive the update message. FIG. 7 illustrates the components of FIG. 6 operating in an execution environment 702 hosted by a node, such as the first NDS node 410. A first NDS server 704 is illustrated in FIG. 7 as also operating in the execution environment 702. In FIG. 7, the update message is received from the network 406 via a network subsystem 706 included in the execution environment 702.

Returning to FIG. 5, in block 504 the second domain is associated with the domain region. Accordingly, a system for resolving a query region to a domain identifier includes means for associating the second domain with the domain region. For example, as illustrated in FIG. 4, a domain manager component 604 is configured to associate the second domain with the domain region.

The message in-router component 602 can be configured to parse the update message and identify the second domain to the domain manager component 604. The message in-router component 602 can be further configured to provide an indication to the domain manager component 604 indicating whether the second domain includes a node having a node region at least partially present in the domain region of the first domain of the first NDS server 704. For example, the indication can be an identifier for the node region. An identifier for any region at least partially present in the domain region will indicate an association should exist and any region that is not at least partially present in the domain region does not indicate an association should.

An identifier can be a command indicating whether an association has been created, changed but still exists, or deleted in the second NDS 412. Since the second domain can include more than one node having a node region at least partially present in the domain region of the first domain, an update involving a node region at least partially present in the domain region of the first domain does not always require the creation of a new association or the removal of an existing association between the second domain and the domain region.

At least one of the second NDS 412 and the first NDS 408 can be configured to determine whether an association should be created or removed. For example, the first NDS node 410 can be configured to send a message to the second NDS node 414 indicating that an association between the second domain and the domain region of the first NDS node 410 exists. The message can be sent in response to receiving an update message from the second NDS node 414 resulting in the creation of the association by the first NDS node 410.

Subsequently, when an association between a network identifier of a node in the second domain and a node region changes, the second NDS node 414 can be configured to determine the type of update. For example, the update can be a new association between a network identifier and a node region included in the domain region, a change to a continuing association, or a deletion of an existing association. The second NDS node 414 can, for example, maintain a count of network identifiers associated with the domain region. When a count is decremented to zero, an update message for removing an existing association between the second domain and the domain region is sent. When a count is incremented from zero to 1 (or when the second NDS server has no record of a domain region including a node region associated with a network identifier of a node in the second domain as a result of an update), a message indicating an association between the second domain and the first domain space is sent.

According to an aspect, the second NDS node 414 can be configured to send an update message for every change in an association between a network identifier of a node in the second domain. The first NDS node 410 can be configured to maintain a count of network identifiers of nodes in the second domain having node regions at least partially present in the domain region. When the network identifier count associated with the second domain is zero, the first NDS node 410 can be configured to ensure no association is maintained between the second domain and the domain region. When the count is above zero, the first NDS node 410 can be configured to ensure an association is maintained between the second domain and the domain region.

When the received update message indicates an association should be removed, the domain manager component 604 can communicate with a database manager component 606 for removing the association from a storage area, such as a domain database 708 included in the execution environment 702. Analogously, when the received update message indicates an association should be created, the domain manager component 604 can communicate with the database manager component 606 for creating the association in the domain database 708. The domain manger 604 and the database manager component 606 can be configured to maintain the network identifier count associated with the second domain in the domain database 708.

According to an aspect, associating the second domain with the domain region includes associating a level of trust with an association of the second domain with the domain region of the first domain. For example, the domain manager component 604 can be configured to associate a level of trust with an association of the second domain with the domain region. Certain domains will have higher levels of trust based on a variety of factors, including, but not limited to, the location, previous communications with the domain, certificates associated with the domain, among others.

Returning to FIG. 5, in block 506 a query message identifying a geospatial query region is received. Accordingly, a system for resolving a query region to a domain identifier includes means for receiving a query message identifying a geospatial query region. For example, as illustrated in FIG. 6, the message in-router component 602 is configured to receive a query message identifying a geospatial query region.

The message in-router component 602 can be further configured to receive a query message. As described above, the query message can be sent from the first node 402 and received by the network subsystem 706 in the execution environment 702 hosted by the first NDS node 410. The message identifies a geospatial query region as described above. The message in-router component 602 can receive the message from the network subsystem 706. Based on parsing the message, the message in-router component 602 can route the message to a component configured to process the type of message determined. The message in-router component 602 can, for example, route the message and/or information based on the message to the domain manager component 604 for processing.

Returning to FIG. 5, in block 508 it is determined that the geospatial query region is at least partially present in the domain region. Accordingly, a system for resolving a query region to a domain identifier includes means for determining that the geospatial query region is at least partially present in the domain region. For example, as illustrated in FIG. 6, a query engine component 608 is configured to determine that the geospatial query region is at least partially present in the domain region.

The domain manager component 604 can be configured to interoperate with the query engine component 608 for processing the query message. For example, the domain manager component 604 can generate a query for locating a domain region that is at least partially present in the geospatial query region identified in the query message. Alternatively, the domain manager component 604 can be configured to identify the geospatial query region to the query engine component 608 and request that the query engine component 608 complete the determination process.

The query engine component 608 can retrieve information identifying the domain region and determine whether there is an overlap between the query region and the domain region identified by the first domain represented by the first NDS server 704 operating in the first NDS node 410. For example, the query engine component 608 can determine the intersection of the two regions. If the intersection is empty then the geospatial query region is not at least partially present in the domain region. When the intersection is non-empty the geospatial query region is at least partially present in the domain region.

In FIG. 7, the query engine component 608 can be configured to receive or generate a query for processing by the database manager component 606 and the domain database 708. The query can be based on the geospatial query region. When the query is processed, an identifier of at least a portion of the domain region can be returned when the geospatial query region is at least partially present in the domain region. When no overlap exists, the domain manager component 604 can be notified. According to an aspect, a response can be generated indicating that the query region and the domain region do not overlap. Alternatively, no response is generated when no overlap exists.

Returning to FIG. 5, in block 510 in response to determining that geospatial query region is at least partially present in the domain region, a response message is sent identifying the second domain. Accordingly, a system for resolving a query region to a domain identifier includes means for sending, in response to determining that geospatial query region is at least partially present in the domain region, a response message identifying the second domain. For example, as illustrated in FIG. 6, a message out-router component 610 is configured to send, in response to determining that geospatial query region is at least partially present in the domain region, a response message identifying the second domain.

When the query engine component 608 determines that the geospatial query region is at least partially present in the domain region, a domain such as the second domain is identified as potentially including a node having a node region that is at least partially present in the query region.

In an alternative, update messages from network directory services representing other domain spaces, such as the second NDS 412, can identify an affected node region in update messages. The first NDS 408 can be configured to associate the second domain with the geospatial region identified by the first domain by maintaining an association between each node region received and the second domain. Such an association can be based on receiving each node region along with an indication that a node in the second domain is associated with the node region, and the node region is at least partially present in the domain region. When the domain manager component 604, the database manager component 606, and the query engine component 608 are configured to maintaining node region associations, the query engine component 608 can determine whether the geospatial query region is at least partially present in a node region.

In FIG. 7, the domain database 708 can process a query for node regions that overlap with the geospatial query region and return domain identifiers of any domain associated with a node region that does overlap with the geospatial query region. Any returned domain identifiers are provided by the query engine component 608 to the domain manger 604.

The domain manager component 604 can generate a response message identifying the domains identified by the query engine component. Alternatively, at least one domain identifier can be provided to the message out-router component 610. The message out-router component 610 can be configured to generate the response message identifying the one or more domains. The second domain can be identified, in FIG. 7, by the domain database 708 as a result of processing a query as directed by the query engine component 608 and the database manager component 606. The second domain can be identified to the domain manager component 604.

In response to determining that the query region is at least partially present in the domain region, the domain manager component 604 can generate a response message identifying the second domain. The response message is provided to the message out-router component 610 for sending the message as a response to the received query message. The message out-router component 610 sends the message to the network subsystem 706 for sending via the network 406 in FIG. 4 to the sender of the query message, the first node 402.

In another aspect, at least one of update message, the received query message, and the response message is formatted according to a publish-subscribe protocol. For example, the message out-router component 610 can be configured to format the response message according to a publish-subscribe protocol, such as a presence protocol. In another aspect, at least one of the update message, the query message, and the response message is formatted according to a domain name system (DNS) protocol. For example, the message-out router component can be configured to format the response message according to a domain name system (DNS) protocol.

According to an aspect, the message in-router component 602 is configured to receive a first network identifier of the node in the update message. The domain manager component 604 can be configured to associate the first network identifier with an association between the second domain and the domain region. Further, the message out-router component 610 can be configured to send, in response to determining that the query region is at least partially present in the domain region, the response message including the identifier of the second domain and the first network identifier.

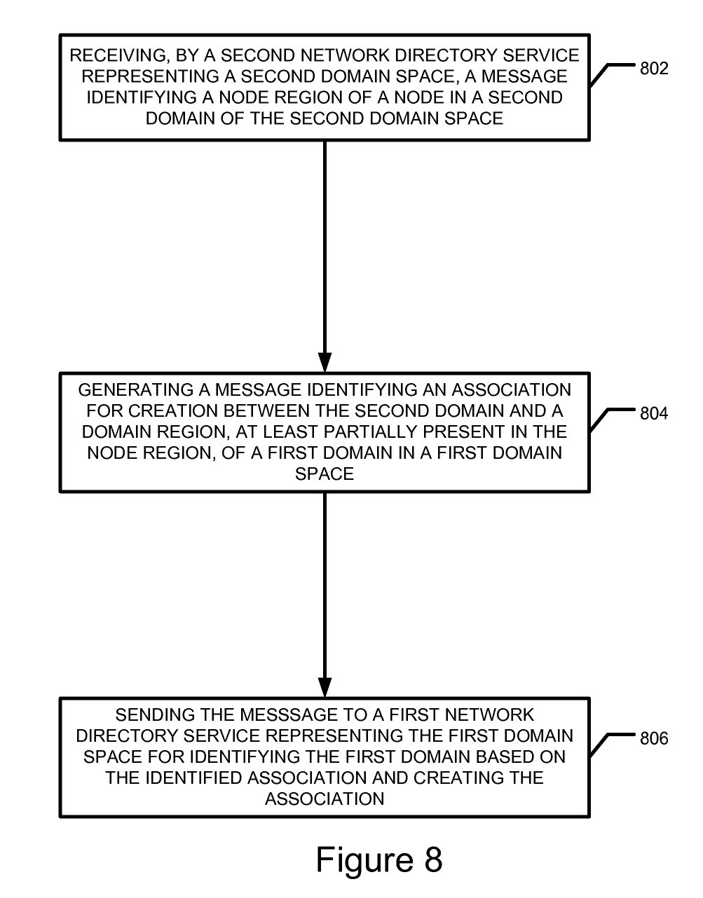

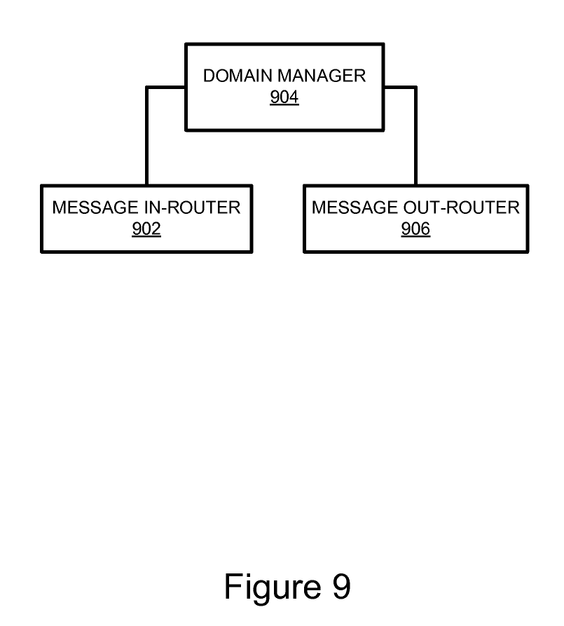

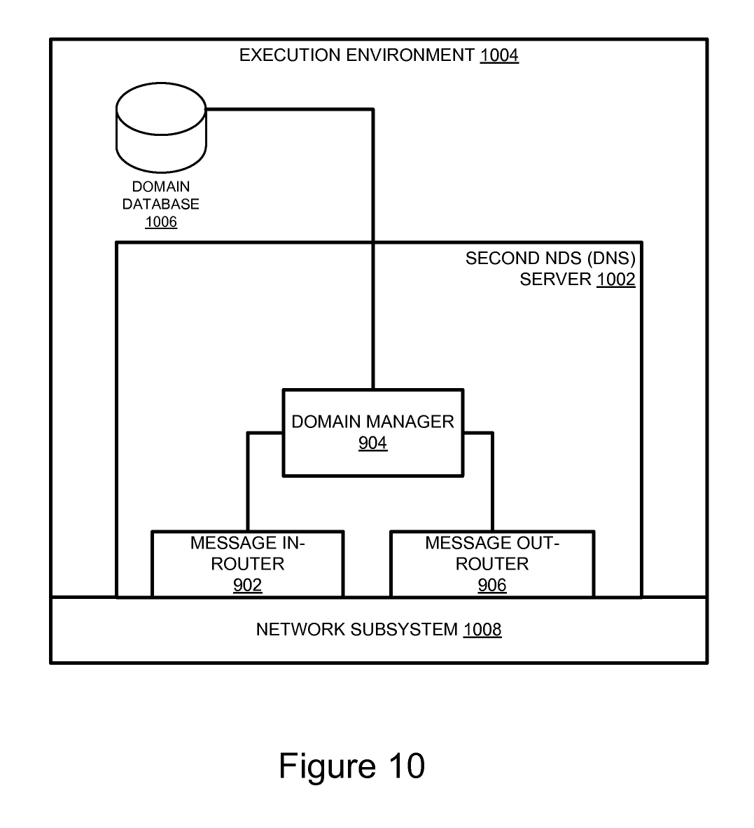

FIG. 8 is a flow diagram illustrating a method for associating a geospatial region with a domain including a node associated with the geospatial region according to an exemplary embodiment of the subject matter described herein. FIG. 9 is a block diagram illustrating an arrangement of components for associating a geospatial region with a domain including a node associated with the geospatial region according to another exemplary embodiment of the subject matter described herein. FIG. 10 is a block diagram illustrating an execution environment configured to host the arrangement of components illustrated in FIG. 9. The method illustrated in FIG. 8 can be carried out by, for example, some or all of the components illustrated in the exemplary arrangement illustrated in FIG. 9 operating in an a compatible execution environment, such as the environment illustrated in FIG. 10.

With reference to FIG. 8, in block 802 a second network directory service representing a second domain space receives a message identifying a node region of a node in a second domain of the second domain space. Accordingly, a system for associating a geospatial region with a domain includes means for receiving, by a second network directory service representing a second domain space, a message identifying a node region of a node in a second domain of the second domain space. For example, as illustrated in FIG. 9, a message in-router component 902 is configured to receive, by a second network directory service representing a second domain space, a message identifying a node region of a node in a second domain of the second domain space.

A message in-router component 902 can be configured to receive a message identifying a node region of a node in a domain of a domain space. For example, the message in-router component 902 can be included in a second NDS server 1002 as illustrated in FIG. 10 along with the other components in FIG. 9. The second NDS server 1002 and the components of FIG. 9 can be adapted for operating in an execution environment 1004 hosted by a node, such as the second NDS node 414. The message identifies a node region of a node in the second domain represented by the second NDS server 1002.

For example, the second node 404 can send a message to the second NDS 412 where the second NDS is a DNS. The message can be a DNS message for creating, updating, or deleting a LOC record maintained by the second NDS node 414, configured for hosting a DNS server. The message can include geospatial information, such as a geospatial identifier, identifying a node region and identifying the second node. For example, the message can provide an IP address of a network interface of the second node 404. The message can be sent as a result of a change in region and/or a change in a network identifier of the second node 404. The message can be routed to the second NDS node 414 via the network 406 for processing by second NDS server 1002.

The message, received by the message in-router component 902, can result in the creation, update, and/or deletion of record in a domain database 1006 included in the execution environment 1004. The network identifier in the message can include a domain portion identifying the second domain. The message can be routed to the second NDS node 414 based on the domain portion of the network identifier. As described with respect to receiving message above, the execution environment 1004 can include a network subsystem 1008 communicatively coupled to the network 406 for receiving the message. The message is received by the message in-router component 902 from the network subsystem 1008.

Returning to FIG. 8, in block 804 a message is generated identifying an association for creation between the second domain and a domain region of a first domain in a first domain space. The domain region is at least partially present in the node region. Accordingly, a system for associating a geospatial region with a domain includes means for generating a message identifying an association for creation between the second domain and a domain region, at least partially present in the node region, of a first domain in a first domain space. For example, as illustrated in FIG. 9, a domain manager component 904 is configured to generate a message identifying an association for creation between the second domain and a domain region, at least partially present in the node region, of a first domain in a first domain space.

The message in-router component 902 can be configured to route the received message based on at least a portion of the message content. The message is provided by the message in-router component 902 to a component of the second NDS server 1002 for processing according to the configuration and requirements of the particular second NDS server 1002. The message can be provided to the domain manager component 904 based on its content. For example, in a DNS system a message for updating a LOC record indicates an association between a network identifier, such as an IP address, of a second node in the second domain and a node region. With respect to the first NDS 408, the message indicates an association should exist between the second domain and a domain region that is at least partially present in the node region where the domain region is associated with a domain in the first NDS 408, such as the first domain represented by the first NDS server 704 operating in the execution environment 702.

The domain manager component 904 is configured to communicate with the first NDS 408 to maintain the association between the second domain and any domain regions that are at least partially present in a node region of a node with a network identifier in the second domain. Based on the received message, the domain manager component 904 generates a message identifying the second domain and indicating an association should exist between the second domain and a domain region at least partially present in the node region. As described above the message can identify the domain region either directly or indirectly. The message can include the same information as the message received by the second NDS 412. For example, in a DNS, the message can include a network identifier of the node and can include an identifier of the node region. The domain portion of the network identifier identifies the second domain and the node region identifies a domain region based on a determined overlap between the node region and one or more domain regions associated with one or more domains in the first NDS 408.

Returning to FIG. 8, in block 806 the message is sent to a first network directory service representing the first domain space for identifying the first domain based on the identified association and creating the association. Accordingly, a system for associating a geospatial region with a domain includes means for sending the message to a first network directory service representing the first domain space for identifying the first domain based on the identified association and creating the association. For example, as illustrated in FIG. 9, a message out-router component 906 is configured to send the message to a first network directory service representing the first domain space for identifying based on the identified association and creating the association.

The domain manager component 904 can be configured to provide the message to the message out-router component 906. The message out-router component 906 is configured to send the message to the first NDS 408. As described above, the message can be sent to a pre-specified address of a first NDS server for routing to one or more first NDS servers associated with domains identifying domain regions that at least partially include the node region and/or identifying domain regions with existing associations that should be removed. The message can be routed based on geospatial information included in the message. For example, the message can be routed to the first NDS node 410.

According to an aspect, the message can be addressed to the first NDS node 410 based on a lookup performed by the second NDS 408 or an associated lookup service as described above. As described above, the first NDS server 704 can determine whether an association should be created, updated, and/or removed based on the message content and information optionally maintained by the first NDS server 704, such as the count associated with the second domain described above. Also described above, the first NDS server 704 can create, update, or remove an association between the second domain and the domain region identified by the first domain based on the determination.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein can be embodied in executable instructions stored in a computer readable medium for use by or in connection with an instruction execution machine, system, apparatus, or device, such as a computer-based or processor-containing machine, system, apparatus, or device. As used here, a “computer readable medium” can include one or more of any suitable media for storing the executable instructions of a computer program in one or more of an electronic, magnetic, optical, electromagnetic, and infrared form, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein can be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for resolving a geospatial query region to a network identifier, the method comprising:
receiving a request identifying a geospatial query region;
sending a first query message identifying the geospatial query region to a first network directory service representing a first domain space including a first domain having a domain region at least partially present in the geospatial query region, the first network directory service including a domain association between a second domain in a second domain space and the domain region identified by the first domain, the domain association indicating a node in the second domain has a node region at least partially present in the domain region;
receiving, based on the domain association, a first response identifying the second domain;
in response to receiving the first response, sending, to a second network directory service, a second query message based on the identified second domain; and
receiving a second response including a network identifier for a node having a node region at least partially present in the geospatial query region.

2. The method of claim 1 wherein the request includes a node portion of a network identifier.

3. The method of claim 2 wherein the node portion is a valid node portion of both a network identifier in the first domain space and a network identifier in the second domain space.

4. The method of claim 1 wherein the request includes a geospatial identifier identifying the geospatial query region.

5. The method of claim 1 wherein receiving the request includes receiving the request by a domain resolver component included in at least one of a client node, wherein the request is received from an application operating in the client node; a network directory service, wherein the request is received from the client node; and a proxy service for responding to the request by interoperating with at least one of the first network directory service and the second network directory service, wherein the request is received from the client node.

6. The method of claim 1 wherein a destination address for the first query message is determined based on an identifier of the first network directory service.

7. The method of claim 1 wherein a destination address for the first query message is determined based on the geospatial query region.

8. The method of claim 1 wherein the second query message includes a matching criterion for determining the network identifier for the node.

9. The method of claim 1 wherein the second response includes an indicator identifying a level of trust of an association between the network identifier and the domain region.

10. The method of claim 1 wherein the second response includes a plurality of network identifiers and further comprising determining the network identifier of the node from the plurality of network identifiers based on a matching criterion.

11. The method of claim 1 wherein at least one of the first query message, the first response, the second query message, and the second response is formatted according to a domain name system (DNS) protocol.

12. The method of claim 1 wherein at least one of the first query message, the first response, the second query message, and the second response is formatted according to a publish-subscribe protocol.

13. The method of claim 1 wherein the second domain space is at least one of an Internet Protocol (IP) address domain space and a domain name system (DNS) domain space.

14. A method for resolving a query region to a domain identifier, the method comprising:
receiving, by a first network directory service representing a first domain space including a first domain having a domain region, an update message identifying a second domain, in a second domain space, including a node having a node region at least partially present in the domain region;
associating the second domain with the domain region;
receiving a query message identifying a geospatial query region;
determining that the geospatial query region is at least partially present in the domain region; and
sending, in response to determining the geospatial query region is at least partially present in the domain region, a response message identifying the second domain.

15. The method of claim 14 wherein at least one of first domain space and the second domain space is a geospatial domain space.

16. The method of claim 14 wherein associating the second domain with the domain region includes associating a level of trust with an association of the second domain with the domain region.

17. The method of claim 14 wherein associating the second domain with the domain region is based on the node region being at least partially present in the domain region

18. The method of claim 14 wherein the domain region is included in a geospatial virtual space.

19. The method of claim 14 wherein at least one of the query region, the domain region and the node region is identified based on geospatial information

20. The method of claim 14 further comprising
receiving a first network identifier of the node in the update message;
associating the first network identifier with an association between the second domain and the domain region; and
sending, in response to determining that the query region is at least partially present in the domain region, the response message including the identifier of the second domain and at least a node portion of the first network identifier.

21. The method of claim 14 wherein at least one of update message, the received query message, and the response message is formatted according to a publish-subscribe protocol.

22. The method of claim 14 wherein at least one of the update message, the query message, and the response message is formatted according to a domain name system (DNS) protocol.

23. A system for resolving a geospatial query region to a network identifier, the system comprising:
means for receiving a request identifying a geospatial query region;
means for sending a first query message identifying the geospatial query region to a first network directory service representing a first domain space including a first domain having a domain region at least partially present in the geospatial query region, the first network directory service including a domain association between a second domain in a second domain space and the domain region identified by the first domain, the domain association indicating a node in the second domain has a node region at least partially present in the domain region;
means for receiving, based on the domain association, a first response identifying the second domain;
means for in response to receiving the first response, sending, to a second network directory service, a second query message based on the identified second domain; and
means for receiving a second response including a network identifier for a node having a node region at least partially present in the geospatial query region.

24. A system for resolving a geospatial query region to a network identifier, the system comprising:
a resolution interface component configured to receive a request identifying a geospatial query region; and
a domain resolver component configured to:
send a first query message identifying the geospatial query region to a first network directory service representing a first domain space including a first domain having a domain region at least partially present in the geospatial query region, the first network directory service including a domain association between a second domain in a second domain space and the domain region identified by the first domain, the domain association indicating a node in the second domain has a node region at least partially present in the domain region;
receive, based on the domain association, a first response identifying the second domain;
in response to receiving the first response, send, to a second network directory service, a second query message based on the identified second domain; and
receive a second response including a network identifier for a node having a node region at least partially present in the geospatial query region.

25. The system of claim 24 wherein the request includes a node portion of a network identifier.

26. The system of claim 25 wherein the node portion is a valid node portion of both a network identifier in the first domain space and a network identifier in the second domain space.

27. The system of claim 24 wherein the request includes a geospatial identifier identifying the geospatial query region.

28. The system of claim 24 wherein receiving the request includes receiving the request by a domain resolver component included in at least one of a client node, wherein the request is received from an application operating in the client node; a network directory service, wherein the request is received from the client node; and a proxy service for responding to the request by interoperating with at least one of the first network directory service and the second network directory service, wherein the request is received from the client node.

29. The system of claim 24 wherein the domain resolver component is configured to determine a destination address for the first query message based on an identifier of the first network directory service.

30. The system of claim 24 wherein the domain resolver component is configured to determine a destination address for the first query message based on the geospatial query region.

31. The system of claim 24 wherein the domain resolver component is configured to include a matching criterion for determining the network identifier for the node in the second query message.

32. The system of claim 24 wherein the second response includes an indicator identifying a level of trust of an association between the network identifier and the domain region.

33. The system of claim 24 wherein the second response includes a plurality of network identifiers and wherein the domain resolver component is configured to determine the network identifier of the node from the plurality of network identifiers based on a matching criterion.

34. The system of claim 24 wherein the domain resolver component is configured to format at least one of the first query message and the second query message according to a domain name system (DNS) protocol.

35. The system of claim 24 wherein the domain resolver component is configured to format at least one of the first query message and the second query message according to a publish-subscribe protocol.

36. The system of claim 24 wherein the second domain space is at least one of an Internet Protocol (IP) address domain space and a domain name system (DNS) domain space.

37. A system for resolving a query region to a domain identifier, the system comprising:
means for receiving, by a first network directory service representing a first domain space including a first domain having a domain region, an update message identifying a second domain, in a second domain space, including a node having a node region at least partially present in the domain region;
means for associating the second domain with the domain region;
means for receiving a query message identifying a geospatial query region;
means for determining that the geospatial query region is at least partially present in the domain region; and
means for sending, in response to determining the geospatial query region is at least partially present in the domain region, a response message identifying the second domain.

38. A system for resolving a query region to a domain identifier, the system comprising:
a message in-router component configured to receive, by a first network directory service representing a first domain space including a first domain having a domain region, an update message identifying a second domain, in a second domain space, including a node having a node region at least partially present in the domain region;
a domain manager component configured to associate the second domain with the domain region;
a message in-router component configured to receive a query message identifying a geospatial query region;
a query engine component configured to determine that the geospatial query region is at least partially present in the domain region; and
a message out-router component configured to send, in response to determining the geospatial query region is at least partially present in the domain region, a response message identifying the second domain.

39. The system of claim 38 wherein at least one of the first domain space and the second domain space is a geospatial domain space.

40. The system of claim 38 wherein the domain manager component is configured to associate a level of trust with an association of the second domain with the domain region.

41. The system of claim 38 wherein the domain manager component is configured to associate the second domain with the domain region based on the node region being at least partially present in the domain region

42. The system of claim 38 wherein the domain region is in a geospatial, virtual space.

43. The system of claim 38 wherein at least one of the query region, the domain region and the node region is identified based on geospatial information

44. The system of claim 38 wherein:
the message in-router is configured to receive a first network identifier of the node in the update message;
the domain manager component is configured to associate the first network identifier with an association between the second domain and the domain region; and
the message out-router is configured to send, in response to determining that the query region is at least partially present in the domain region, the response message including the identifier of the second domain and at least a node portion of the first network identifier.

45. The system of claim 38 wherein the message out-router component is configured to format the response message according to a publish-subscribe protocol.

46. The system of claim 38 wherein the message-out router component is configured to format the response message according to a domain name system (DNS) protocol.

47. A computer readable medium embodying a computer program, executable by a machine, for resolving a geospatial query region to a network identifier, the computer program comprising executable instructions for:
receiving a request identifying a geospatial query region;
sending a first query message identifying the geospatial query region to a first network directory service representing a first domain space including a first domain having a domain region at least partially present in the geospatial query region, the first network directory service including a domain association between a second domain in a second domain space and the domain region identified by the first domain, the domain association indicating a node in the second domain has a node region at least partially present in the domain region;
receiving, based on the domain association, a first response identifying the second domain;
in response to receiving the first response, sending, to a second network directory service, a second query message based on the identified second domain; and
receiving a second response including a network identifier for a node having a node region at least partially present in the geospatial query region.

48. A computer readable medium embodying a computer program, executable by a machine, for resolving a query region to a domain identifier, the computer program comprising executable instructions for:
receiving, by a first network directory service representing a first domain space including a first domain having a domain region, an update message identifying a second domain, in a second domain space, including a node having a node region at least partially present in the domain region;
associating the second domain with the domain region;
receiving a query message identifying a geospatial query region;
determining that the geospatial query region is at least partially present in the domain region; and
sending, in response to determining that geospatial query region is at least partially present in the domain region, a response message identifying the second domain.

49. A method for associating a geospatial region with a domain including a node associated with the geospatial region, the method comprising
receiving, by a second network directory service representing a second domain space, a message identifying a node region of a node in a second domain of the second domain space;
generating a message identifying an association for creation between the second domain and a domain region, at least partially present in the node region, of a first domain in a first domain space; and
sending the message to a first network directory service representing the first domain space for identifying the first domain based on the identified association and creating the association.

50. A system for associating a geospatial region with a domain including a node associated with the geospatial region, the system including
a message in-router component configured to receive, by a second network directory service representing a second domain space, a message identifying a node region of a node in a second domain of the second domain space;
a domain manager component configured to generate a message identifying an association for creation between the second domain and a domain region, at least partially present in the node region, of a first domain in a first domain space; and
a message out-router component configured to send the message to a first network directory service representing the first domain space for identifying the first domain based on the identified association and creating the association.

51. A computer readable medium embodying a computer program, executable by a machine, for associating a geospatial region with a domain including a node associated with the geospatial region, the computer program comprising executable instructions for:
receiving, by a second network directory service representing a second domain space, a message identifying a node region of a node in a second domain of the second domain space;
generating a message identifying an association for creation between the second domain and a domain region, at least partially present in the node region, of a first domain in a first domain space; and
sending the message to a first network directory service representing the first domain space for identifying the first domain based on the identified association and creating the association.
